(19) United States
(12) Patent Application Publication
(10) Pub. No.: US 2025/0165074 A1
(43) Pub. Date: May 22, 2025

(54) Haptic and sound interface

(71) Applicant: COMMISSARIAT A L'ENERGIE ATOMIQUE ET AUX ENERGIES ALTERNATIVES, PARIS (FR)

(72) Inventors: Fabrice CASSET, GRENOBLE (FR); Angélique RASCLE, GRENOBLE (FR); Christophe PRAT, GRENOBLE (FR); Laurent GERFAULT, GRENOBLE (FR); Sébastien BRULAIS, GRENOBLE (FR); Laure PERIS Y SABORIT, Grenoble (FR)

(21) Appl. No.: 18/915,671

(22) Filed: Oct. 15, 2024

(30) Foreign Application Priority Data
Oct. 17, 2023 (FR) 2311179

(51) Int. Cl. G06F 3/01; G06F 3/043

(52) U.S. Cl. CPC G06F 3/016; G06F 3/043

(57) ABSTRACT

A multimodal haptic interface has a control circuit and an an array with a plurality of ultrasound transducers connected to the circuit. The control circuit is configured to modulate the signals sent to the transducers in order to generate, with the ultrasound waves emitted by at least some of the transducers, an acoustic pressure that is tactilely detectable in at least one first focal zone; and/or generate, with the ultrasound waves emitted by at least some of the transducers, an acoustic pressure that is audibly detectable in at least one second focal zone.

### RELATED APPLICATION

This application claims the benefit of priority from French Patent Application No. 23 11179, Oct. 17, 2023, the entirety of which is incorporated by reference.

### TECHNICAL FIELD

The present invention relates to human-machine interfaces, and more specifically to those using haptic and sound effects.

### PRIOR ART

### Haptic Interface

A haptic interface allows the user to interact with the environment through the sense of touch. The haptic effect is currently increasingly used in numerous applications, notably for virtual or augmented reality devices.

The use of an array of ultrasound transducers excited at a frequency, called carrier frequency, above 20 kHz is known for generating a plurality of ultrasound waves, which, although not audible, are focused by adjusting the phase shift of the carriers in a predefined zone of space in order to generate acoustic pressure. This pressure is perceptible to the touch by virtue of low-frequency modulation of the amplitude of the carriers.

Hereafter, “carrier frequency of the transducers” refers to the frequency of the excitation signal for the transducers, in other words their working frequency, which excitation signal can be amplitude modulated in order to generate the haptic or sound information that is to be transmitted.

Notably, activating transducers individually or in groups is known for generating a non-audible acoustic pulse, with control electronics being arranged to carefully phase-shift the activation of each transducer in order to focus the ultrasound waves on a selected point in space. This single-point acoustic focusing technique allows elementary acoustic pulses to be added and therefore allows acoustic pulses to be generated that are strong enough to be felt by the user.

This technology, which generates an effect in mid-air, allows, for example, better immersion in video games, notably by adding haptic effects when using virtual reality (VR), augmented reality (AR) or mixed reality (MR) glasses. It also can be applied to the functionalization of dashboards, notably in automobiles, by allowing the driver to obtain tactile information while keeping their attention on the road.

Application US 2018/0181203 discloses a haptic interface for generating a haptic effect on the hand of a user by virtue of an array of ultrasound transducers with identical carrier frequencies, but with different low-frequency modulation frequencies, in order to solicit different tactile receptors sensitive to different excitation frequencies and thus create a multipoint haptic effect.

Application FR 3092680 describes a virtual reality device comprising a mount intended to be worn on the head of a user and comprising a plurality of identical ultrasound transducers of the piezoelectric micromachined (PMUT) type generating a haptic effect on the hand of the user.

Application FR 3116630 describes a “mid-air” type haptic interface comprising two sets of transducers emitting at different carrier frequencies.

Application US 2018/151035 describes a “mid-air” type haptic emission device configured to emit ultrasound signals at non-audible frequencies, in order to generate tactile effects on a user without disturbing other people present in the immediate vicinity.

U.S. Pat. No. 11,347,312 describes a system comprising a plurality of “mid-air” type haptic devices that can be activated or deactivated so as to generate haptic effects in various zones, with each haptic device allowing haptic effects to be generated in one of the zones.

### Sound Interface

Loudspeakers are known that receive an analogue signal and comprise a membrane that will reproduce the sound to be played as a function of its position and its movement.

The use of a large number of small transducers is also known for reconstructing a sound to be played using the principle of linear additivity of air pressures, as described in the article by Dejaeger et al., entitled, “Development and characterization of a piezoelectrically actuated MEMS digital loudspeaker”, Proceedings European Conference on Sensors, Actuators and Microsystems (Eurosensor), 2012, as well as in the thesis by Rémy Dejaeger entitled, “Multiphysical modeling, production and tests on a digital MEMS piezoelectric loudspeaker”, Acoustics [physics. class-ph], Lyon INSA, 2014, French. In these documents, a certain number of transducers are activated in order to obtain a general pressure pulse with a certain amplitude.

### Multimodal System

Assemblies are known from the prior art that combine both haptic and visual effects, by virtue of the use of separate systems, with the visual effects being generated, for example, by virtue of holograms or mirrors, and the haptic effects being generated by an array of ultrasound transducers.

### DISCLOSURE OF THE INVENTION

There is still a need to benefit from an interface that can generate both localized “mid-air” haptic effects and localized sound effects.

### SUMMARY OF THE INVENTION

The invention aims to meet this need and, according to a first aspect thereof, achieves this aim by virtue of a “mid-air” type multimodal haptic and sound interface, comprising:
a control circuit;
an array comprising a plurality of ultrasound transducers connected to said circuit;
   with the control circuit being configured to modulate the signals sent to the transducers in order to:
generate, with the ultrasound waves emitted by at least some of the transducers, an acoustic pressure that is tactilely detectable in at least one first focal zone; and
generate, with the ultrasound waves emitted by at least some of the transducers, an acoustic pressure that is audibly detectable in at least one second focal zone.

The term “focal zone”, sometimes also called “focal point”, refers to the zone where the ultrasound waves are concentrated and generate a detectable acoustic pressure. This focal zone can be a more or less extensive region in space, depending on the intended aim.

The interface according to the invention can allow an acoustic pressure to be generated that can be tactilely detected and/or an acoustic pressure to be generated that can be audibly detected by the same user.

The multimodal interface according to the invention can allow the audibly detectable acoustic pressure to be generated by electronic acoustic focusing. In particular, the control circuit can be configured to modulate the signals sent to the transducers in order to generate the audibly detectable acoustic pressure, by electronic acoustic focusing.

The interface according to the invention allows transducers to be activated by introducing a phase shift on each activated transducer, in order to spatially localize a haptic effect and/or a sound effect.

The invention allows spatially and/or temporally coherent sound effects and haptic effects to be generated.

The invention allows the creation of haptic and sound effects to be generated simultaneously, notably by virtue of different transducer carrier frequencies and/or different numbers of activated transducers for the two effects and/or varied phase shifts between the transducers.

The invention also allows haptic effects and sound effects to be successively generated by stimulating the same transducers. The two successive effects can be perceived to be simultaneous by a user if the time separating them is less than or equal to a few hundred, better still a few dozen, milliseconds, for example, if the time separating them is less than or equal to 1,000 ms, or even 100 ms.

The invention can allow haptic effects to be generated with a spatial resolution (size of the focal spot) ranging between 1 mm and 30 cm, better still between 2 mm and 1 cm.

The invention can also allow sound effects to be generated with a spatial resolution ranging between 1 cm and 8 cm.

The invention can allow, if desired, the first focal zone to be quickly moved in order to give the user the impression of a large object.

### Control Circuit

The control circuit is preferably configured to determine the number of transducers to be activated in order to achieve the desired haptic and/or sound effects, as well as their position in the array of transducers.

The control circuit is preferably configured so as to compute the phase shifts to be introduced into the carriers of the various ultrasound waves emitted by the activated transducers, and to generate these phase shifts so as to concentrate the emitted ultrasound waves in predefined focal zones.

The control circuit notably uses algorithms that are known to a person skilled in the art in order to determine the number of transducers to be activated and/or their position and/or in order to compute the phase shifts to be introduced into the carriers of the various ultrasound waves emitted by the activated transducers. Such an example of an algorithm that is known to a person skilled in the art is described in the article by Hudin C., Lozada J., Hayward V. entitled, “Localized Tactile Feedback on a Transparent Surface through Time-Reversal Wave Focusing”, IEEE Trans Haptics, 2015 April-June; 8 (2): 188-98.

The control circuit can receive data from an equipment defining the one or more haptic and/or sound effects to be generated, as a function of, for example, the position of the hand and/or ear of the person for whom this (these) effect(s) is (are) intended, relative to the transducers. The control circuit can be configured to determine which transducers to activate and which signals to be sent with them in order to generate the desired haptic and/or sound effect(s).

### Multimodal Interface

The interface can comprise at least one set of transducers arranged to generate haptic effects and sound effects.

The interface can comprise at least two sets of ultrasound transducers, and notably can have exactly two.

A first set of transducers can be arranged to generate haptic effects and a second set of transducers can be arranged to generate sound effects at the same time as and/or after the haptic effects generated by the first set, notably a first set of transducers can be arranged with the control circuit to generate haptic effects and a second set of transducers not included in the first set can be arranged to generate, with the control circuit, sound effects at the same time as and/or after the haptic effects generated by the first set. For example, the haptic effects generated by the first set are generated on a surface of a user, such as one of their hands or fingers, and the sound effects generated by the second set are generated so as to be perceived by an auditory receiver of this user, such as one of their ears.

Preferably, one from among a first set and a second set of transducers is at least partly, better still fully, included in the other one from among the first and the second set of transducers.

The two sets of transducers can comprise various numbers of transducers.

A first set can comprise between 100 and 200 transducers.

A second set can comprise between 200 and 500 transducers.

The transducers of a first set and those of a second set can have identical active membranes. The transducers of a first set and those of a second set can have active membranes with different sizes, preferably made in the same manner.

The transducers of a first set and of a second set can operate with identical carrier frequencies. As a variant, the transducers of a first set and of a second set can operate with different carrier frequencies.

The transducers can be arranged to operate at different carrier frequencies in a variety of ways. For a given transducer, the carrier frequency can correspond to the resonant frequency of the transducer. For example, the size of the transducer or the materials used can be adjusted, both of these parameters affecting the resonant frequency. For example, the transducers of a first set and those of a second set have active membranes with different sizes, preferably made in the same manner, notably with the same material or materials. This simplifies the production of the transducers, by allowing, if desired, simultaneous production, for example, on the same support, of a plurality of transducers, including some with a given membrane size and others with a different membrane size. The transducers with the largest active membrane can emit at the lowest carrier frequency.

The transducers of a first set and those of a second set can be amplitude modulated at an identical low frequency, or, as a variant, at different frequencies.

The low modulation frequency of the carriers preferably ranges between 10 Hz and 5 kHz, better still between 50 Hz and 500 Hz.

The transducers of a first set can be consolidated into one or more sub-sets, as can those of a second set.

The transducers of a first set and those of a second set are preferably supported by the same support. This support can be rigid or flexible, and can assume, for example, a variety of configurations, notably concave or convex, depending on the desired effects.

Preferably, the first focal zone is different from the second focal zone. The focal zones can be located at different points in space and/or can be different sizes. For example, the focal zones can be located at different points on the same user.

The interface can comprise several, notably two or three, sets of transducers arranged to simultaneously create haptic effects at different spatial positions.

### Detection System

The interface can comprise at least one detection system configured to detect the position of at least one surface to be tactilely stimulated and/or of at least one auditory receiver to be audibly stimulated relative to the transducers.

The control circuit can be arranged to control the transducers, notably the position of the first and second focal zones, as a function of the position of the surface and/or of the auditory receiver.

The detection system can use at least some of the ultrasound transducers for this detection, by analyzing the return signal reflected on the user, like a sonar. The detection system can also use any other system, for example, an optical or capacitive system, suitable for this detection.

If necessary, the detection system can be used to allow the interface to transition from a standby state to an active state, or vice versa.

### Transducers

Each transducer can be of any type, piezoelectric, ferroelectric, electromagnetic or thermal. For piezoelectric transducers, the materials can be deposited in thin films or can be formed from ceramic piezoelectric materials. Preferably, the transducer is of the piezoelectric type, notably of the piezoelectric micromachined (PMUT) type, with this type of transducer being suitable for simultaneously producing a large number of transducers.

The transducers emit, for example, in a carrier frequency range of 20 kHz-150 kHz, and more generally any frequency range above the audible range.

The transducers can range between 50 μm and 5,000 μm in size, notably between 150 μm and 1,000 μm.

### Distribution of the Transducers

The spacing between the transducers can range between 10 μm and 10,000 μm, better still between 100 μm and 500 μm. This spacing is sufficient to provide an interface that is rigid enough to be manufactured.

In one example, the sets of transducers are arranged so as to be distributed in a generally nested manner in order of carrier frequency height. For example, the transducers are arranged as a generally concentric arrangement in order of active membrane size, with the set with the smallest active membrane, i.e., emitting at the highest frequency, being located in the center, for example. Other arrangements are possible, for example, alternating sets of transducers with different carrier frequencies in one or two directions, or sets of transducers located at different levels, or pointing in different directions.

### Use

The interface according to the invention can be used in applications such as virtual reality, mixed reality or augmented reality headsets and glasses.

### Method

A further object of the invention is a method for generating one or more mid-air localized tactile and/or sound perceptions using a multimodal interface as defined above, comprising modulating the control signals sent to the transducers by virtue of a control circuit in order to:
generate, with the ultrasound waves emitted by the actuated transducers, an acoustic pressure that is tactilely detectable on a surface of a user, in a first focal zone; and/or
generate, with the ultrasound waves emitted by the actuated transducers, an acoustic pressure that is audibly detectable by an auditory receiver of the user, in a second focal zone.

The method can comprise the following steps:
determining the one or more spatial positions where the tactile and/or sound perception is to be generated;
determining the transducers to be actuated and computing the phase shift to be applied to these transducers in order to generate the one or more desired tactile and/or sound perceptions.

The first focal zone and the second focal zone can be partly superimposed, notably coincident. As a variant, the first focal zone and the second focal zone are separate from each other. Preferably, the first focal zone and the second focal zone are located on the same user.

### BRIEF DESCRIPTION OF THE DRAWINGS

The invention will be better understood upon reading the following detailed description of non-limiting embodiments thereof, and with reference to the appended drawings, in which:

FIG. 1A partially and schematically shows an example of a “mid-air” type haptic and sound interface according to the invention;

FIG. 1B schematically illustrates the principle of focusing ultrasound waves by adjusting the phase shift;

FIG. 2 is a partial and schematic top view of an example of an ultrasound transducer;

FIG. 3 partially and schematically shows an embodiment of an array of transducers comprising transducers with different sizes;

FIG. 4a partially and schematically shows an embodiment of a set of arrays of transducers;

FIG. 4b partially and schematically shows another embodiment of a set of arrays of transducers;

FIG. 4c partially and schematically shows another embodiment of a set of arrays of transducers;

FIG. 5 is a partial and schematic cross-section of an embodiment of a PMUT-type ultrasound transducer;

FIG. 6 is a block diagram illustrating the steps of an example of a method for manufacturing a plurality of PMUT-type ultrasound transducers;

FIG. 7 is a schematic and partial cross-section illustrating the second step of FIG. 6;

FIG. 8 is a partial and schematic cross-section of the plurality of PMUT-type transducers after the third step of FIG. 6;

FIG. 9 is a partial and schematic cross-section of the plurality of PMUT-type transducers of FIG. 6 before being organized in arrays;

FIG. 10 is a partial and schematic cross-section illustrating an example of the electrical connection of the transducer of FIG. 5;

FIG. 11 is a block diagram illustrating an example of the operation of the haptic interface according to the invention;

FIG. 12 illustrates measurements of the sound pressure generated by a PMUT transducer operating at a frequency of 100 kHz and being powered by a voltage of 5 V; and

FIG. 13 illustrates measurements of the sound pressure generated by an array of 64 PMUT transducers operating at a frequency of 100 kHz.

### DETAILED DESCRIPTION

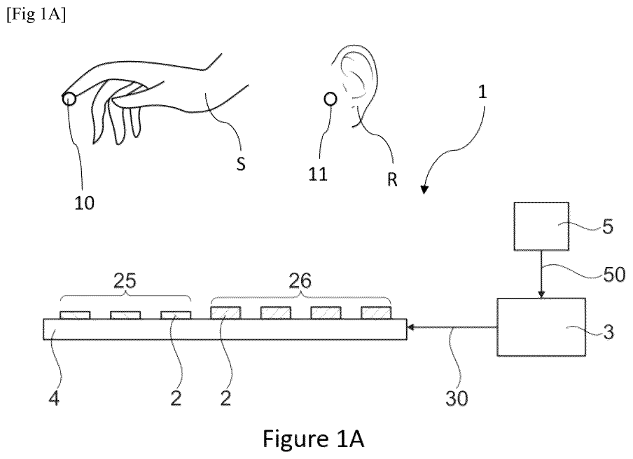

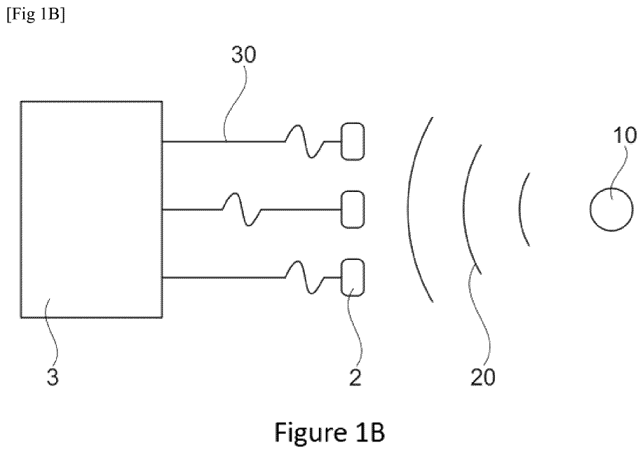

FIG. 1A schematically illustrates an example of a haptic and sound interface 1 according to the invention.

The interface 1 comprises a plurality of ultrasound transducers 2, for example, supported by the same support 4, and a control circuit 3.

The plurality of transducers 2 comprises a first set 25 of transducers emitting at a first ultrasound carrier frequency and a second set 26 of transducers emitting at a second ultrasound carrier frequency, different from the first ultrasound carrier frequency. As a variant, and preferably, the transmission carrier frequencies of the sets 25 and 26 are the same.

The sets 25 and 26 can be separate, as illustrated in FIG. 1A. As a variant, they are combined or one of the sets 25 or 26 is included in the other set.

The control circuit 3 is configured to modulate the signals 30 sent to the transducers 2 in order to generate, with the ultrasound waves emitted by the first set of transducers, an acoustic pressure that is tactilely detectable on a surface S, defined, for example, by the palm and/or the fingers of a hand, in a first focal zone 10, and/or in order to generate, with the ultrasound waves emitted by the second set of transducers, an acoustic pressure that is audibly detectable by an auditory receiver R, defined, for example, by an ear, in a second focal zone 11. FIG. 1A is schematic, and in practice this second focal zone 11 is not on the ear but in the space around the user, ideally in the vicinity of the ear to ensure that hearing is possible despite the limited acoustic pressures. Each focal zone has spatial features that notably depend on the carrier frequency of the set of transducers generating the corresponding acoustic pressure.

The focal zones 10 and 11 can be located at distinct points in space or can at least partially overlap. They may or may not be of different sizes.

The acoustic pressures that can be tactilely detected by the user are generated by the transducers using a principle called “electronic acoustic focusing” that is known in the prior art, as schematically illustrated in FIG. 1B.

FIG. 1B illustrates the focusing of the ultrasound waves 20 emitted by the transducers 2 of the same set of transducers in a predefined focal zone 10. In a manner known per se, the control circuit 3 sends complex alternating signals 30 to the transducers 2 in order to introduce phase shifts between the various ultrasound waves emitted by the activated transducers 2, thus generating the desired wavefront shape, with this wavefront shape resulting in an increase in the acoustic pressure in the focal zone 10.

The acoustic pressures that are audibly detectable by the user are also generated by the transducers according to the principle of electronic acoustic focusing, as described in the article by Dejeager et al., mentioned in the introduction.

In the considered example, the interface 1 further comprises a detection system 5 configured to detect the position of the surface S of the user to be tactilely stimulated and that of the receiver R of this user to be audibly stimulated. The detection system 5 is configured to transmit corresponding location data 50 to the control circuit 3. The interface 1 is of the “mid-air”type because the surface S to be tactilely stimulated and the receiver R to be audibly stimulated are located at a distance from the transducers 2, and the focal zones 10 and 11 are located in the air at a distance from the transducers, being visually invisible to the user.

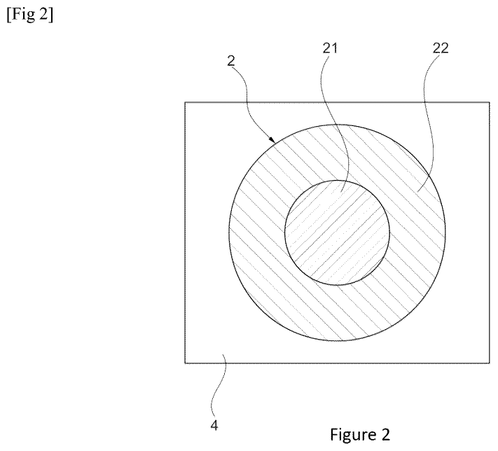

FIG. 2 shows an example of a transducer 2 supported by a support 4. The transducer 2 comprises, for example, a piezoelectric actuator 21 and an active membrane 22 vibrated by the actuator 21.

In the considered example, the active membrane 22 is circular. In other embodiments, the active membrane 22 is non-circular, for example, polygonal, notably square, rectangular, or any other suitable shape, 2D or 3D, and the membrane can be convex or concave. The radius of the piezoelectric actuator 21 is, for example, of the order of 50% of the radius of the active membrane 21, with this ratio being advantageous for proper deformation of the membrane, as described in the article by Casset F., et al., entitled, “Piezoelectric membrane actuator design.” (2011 12th Intl. Conf. on Thermal, Mechanical & Multi-Physics Simulation and Experiments in Microelectronics and Microsystems. IEEE, 2011).

Within each set of transducers, said transducers are identical and therefore emit at the same carrier frequency. From one set to another, the transducers 2 differ in size, for example, with each size corresponding to a respective carrier frequency. The active membrane 22 of the transducers 2 varies, for example, in terms of thickness and/or radius, preferably in terms of radius, from one set to another.

The transducers of the various sets of the interface according to the invention can be arranged within one or more arrays 40. The term “array” refers to a single-piece structure supporting several transducers, which may or may not be identical. An array can comprise transducers that have been produced at the same time, as described below.

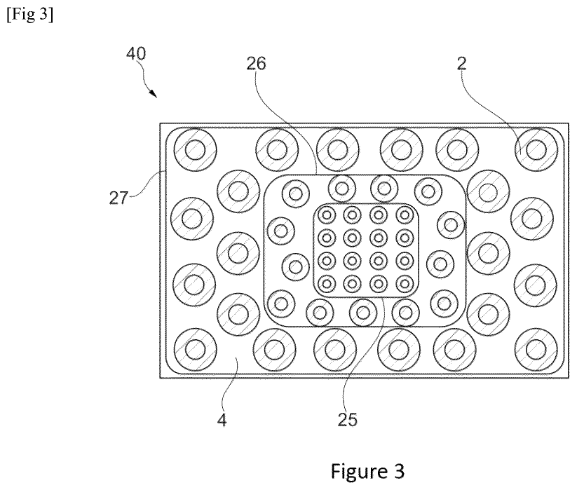

FIG. 3 shows an array 40 of ultrasound transducers 2 comprising three sets 25, 26 and 27 of transducers with different respective sizes, with the transducers 2 being arranged on the support 4 as a concentric distribution, for example, as illustrated. For example, the set 25 corresponds to the set comprising the smallest transducers 2, arranged in the center of the array, the set 26 corresponds to the set comprising the intermediate-sized transducers 2, and the set 27 corresponds to the set comprising the largest transducers 2, distributed around the periphery of the array.

The active membranes 22 of the transducers 2 of the sets 25, 26 and 27 have, for example, radii of 1,000, 1,600 and 2,200 micrometers, respectively. The carrier frequency f corresponding to a given membrane size can be estimated using the following equation, taken from the article by Nguyen M. D., et al., entitled, “Optimized electrode coverage of membrane actuators based on epitaxial PZT thin films.” (Smart materials and structures 22.8 (2013): 085013.):

$$f = \frac{{λ}_{n}^{2} t}{2 π {r}^{2}} \sqrt{\frac{E}{12 ρ ( 1 - v )}}$$

with E and ν being the Young's modulus and the Poisson's ratio of the membrane, respectively, ρ being its average mass density, t being its thickness and r being its radius. λₙ is the resonant eigenvalue of the membrane, with n being the resonant mode.

In the considered example, the carrier frequency of the transducers 2 of the sets 25, 26 and 27 is thus approximately 107 kHz, 44 kHz and 22 kHz, respectively. According to these frequencies, the haptic effect can be generated at a distance of the order of 8 cm to 1 m.

The transducers from different sets can be arranged within the same array 40 in a variety of ways, for example, generally concentrically, as illustrated in FIG. 3, or even can be mixed randomly or according to other rules for arranging the transducers relative to each other.

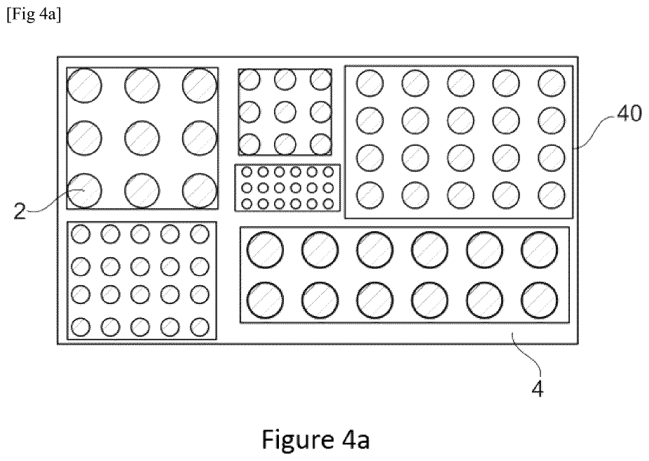

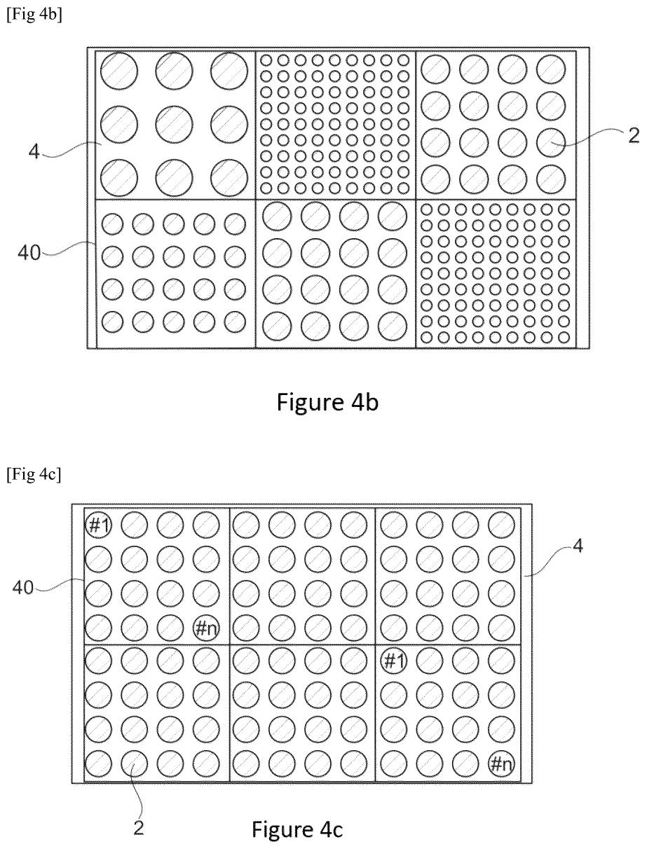

In other embodiments, as illustrated, for example, in FIGS. 4a, 4b and 4c, the sets are arranged on separate respective arrays 40, which are consolidated, for example, with the arrays 40 being assembled in a common plane, for example. The arrays 40 can assume different sizes and shapes, as in FIG. 4a, or can assume a similar size, as in FIG. 4b. The membranes 22 of the transducers 2 of each array 40 can differ in terms of thickness, as illustrated in FIG. 4c. Preferably, the membranes 22 of the transducers 2 of the arrays 40 are identical, and notably the membranes 22 of the transducers 2 of the sets 25, 26 and 27 are identical. This limits the number of membranes required to produce haptic and/or sound effects.

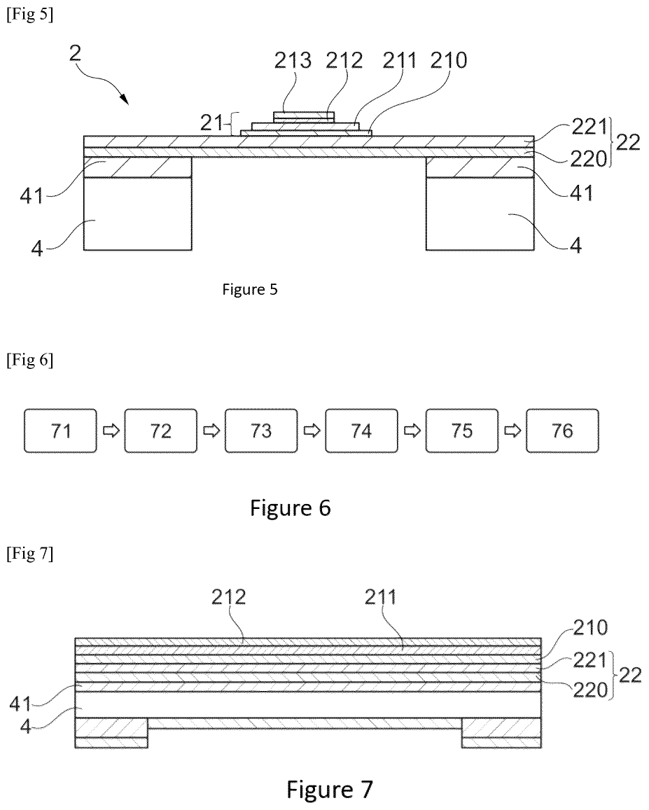

FIG. 5 shows an embodiment of a transducer 2 of the interface 1. In the considered example, the transducer 2 is of the piezoelectric micromachined (PMUT) type and comprises, as previously described, an active membrane 22 fixed to a rigid support 4 and a piezoelectric actuator 21 arranged on the membrane 22.

The rigid support 4 is made of silicon, for example. An insulating film 41, for example, made of silicon oxide, can be added between the support 4 and the membrane 22. The membrane 22 is fixed to the support only over its periphery, with its central part being free to bend.

The membrane 22 is formed by one or more superimposed constituent films and has a total thickness that ranges between 0.5 and 10 μm, for example. In the considered example, the membrane 22 is made up of two superimposed films 220 and 221. The lower film 220 is made of polysilicon, for example, and is 4 μm thick. The upper film 221 is made of silicon oxide, for example, and is 1.9 μm thick. Other materials can be used for the membrane 22, notably materials based on monocrystalline silicon or silicon nitride.

The piezoelectric actuator 21 comprises, for example, four superimposed films 210, 211, 212 and 213. The film 210 is in contact with the upper film 221 of the membrane 22. The film 210 is made of platinum, for example, and forms the lower electrode of the actuator 21. The upper electrode of the actuator in this example comprises a film 212, for example, made of ruthenium, and a conductive film 213, for example, made of gold. The film 211 that is located between the two electrodes is made of a piezoelectric or ferroelectric material, for example, of the lead titano-zirconate (PZT) type. It also can be made of aluminum nitride (AlN), zinc oxide (ZnO) or any other suitable piezoelectric or ferroelectric material.

In order to obtain the PMUT transducer illustrated in FIG. 5, a manufacturing method can be implemented that comprises the steps shown in FIG. 6, allowing a large number of transducers to be produced simultaneously.

In step 71, one or more films, for example, 4 μm thick films, for example, made of polysilicon and silicon oxide, are deposited onto the upper surface of a rigid substrate 4, for example, made of silicon, in order to form the active membranes 22 of the transducers. An insulating film 41 can be deposited beforehand between the substrate 4 and the first film of the membrane.

In step 72, the materials that will form the piezoelectric actuators 21 are successively deposited as thin films. For example, a 100 nm film of platinum 210 is initially deposited in order to form the lower electrode, and is then covered with a 2 μm film 211 of a PZT-type piezoelectric material, which is then itself covered with a thin 100 nm film of ruthenium 212. On completion of step 72, and as illustrated in FIG. 7, a continuous stack of the previously described films is obtained, namely from bottom to top: the support 4, the insulating film 41, the films 220 and 221 forming the membrane 22, and the films 210, 211 and 212 forming the piezoelectric actuator 21.

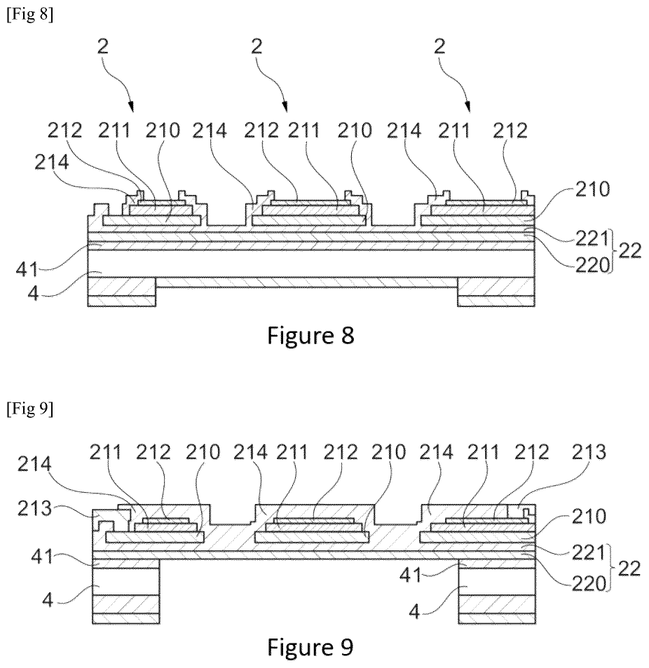

In step 73, and as illustrated in FIG. 8, the plurality of transducers is then formed on the support 4 by applying photolithography masks and by etching the films 210, 211 and 212 forming the piezoelectric actuator. This step can further comprise applying a passivation insulating film 214, for example, made of silicon oxide, and a conductive film 213, for example, made of gold, to at least part of the film 212.

In step 74, the lower face of the support 4 and the insulating film 41 are cut, for example, by applying a mask and then etching, so as to expose the lower face of the central part of the active membrane 22 of each transducer, as illustrated in FIG. 9.

In this way, a plurality of transducers can be simultaneously produced on the same support in a simple manner. In step 75, the support then can be cut in order to obtain arrays 40 of transducers of the desired size. The size and the thickness of the membranes can be adjusted in order to obtain transducers with different frequencies.

In step 76, each transducer is electrically connected to control electronics by virtue of through connections 7, for example.

In order to electrically connect the transducers thus obtained to their control electronics, flexible connectors can be connected to each of the transducers.

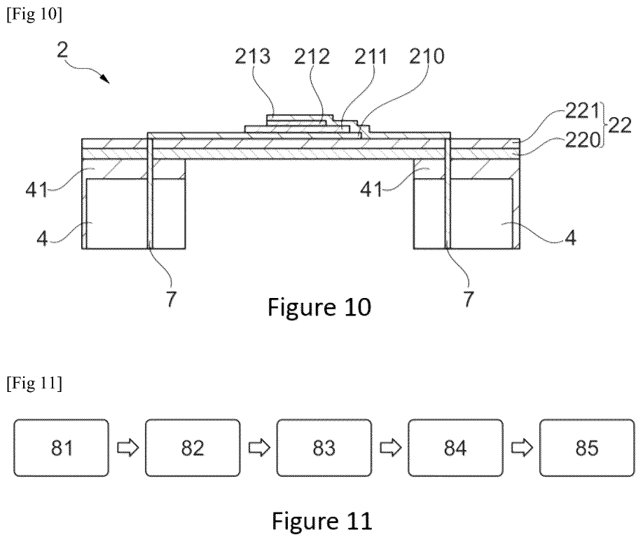

The resulting arrays 40 then can be integrated into a housing and the flexible connectors can be connected to the control electronics. Alternatively, and as illustrated in FIG. 10, through connections 7 can be used to route electrical contacts to the lower face of the support 4. The arrays 40 of transducers then can be directly integrated into the control electronics.

When a voltage difference is applied between the electrodes 210 and 213, the piezoelectric film 211 can deform under the action of the generated electric field, inducing the deformation of the active membrane 22 and the emission of an acoustic wave. Conversely, the transducer 2 thus connected can act as an acoustic wave receiver, for example, as a system for detecting the surface S on which the haptic effect must be generated and/or the receiver R on which the sound effect must be generated. In this case, the reception of an acoustic wave deforms the film 211 and therefore the membrane 22, causing a variation in the electric field that can be expressed by an electrical signal on the electrodes, measured using the electrical connections 7.

A haptic and sound interface 1 according to the invention, coupled with a detection system 5, can operate according to the steps described in FIG. 11.

In step 81, the interface 1 is on standby, for example, in the absence of a user in the detection field of the detection system 5. In step 82, the detection system 5, for example, made with some of the transducers 2 or with any other suitable detection system, for example, a camera, for example, an optical camera, detects the presence of a surface S and/or a receiver R of a user in the detection field, and locates the site where the one or more haptic and/or sound effects must be generated. In step 83, the control circuit 3 computes, using algorithms that are known to a person skilled in the art, the phase shift to be applied to the transducers and sends the appropriate control signals 30 in order to activate at least some of the transducers 2 so as to generate the one or more desired haptic and/or sound effects. In step 84, the transducers emit ultrasound waves at different carrier frequencies, depending on which sets are activated, allowing one or more haptic and/or sound effects to be generated in one or more focal zones. In step 85, the user withdraws from the detection field and the interface 1 returns to standby.

The working frequencies of the transducers 2 used for the haptic and sound effects can be different or identical. If the frequencies are the same, the array 40 comprising the transducers 2 used for the haptic and sound effects can be monolithic and manufactured at the same time, for example, using the method described in FIG. 6. If the frequencies are different, the array 40 also can be produced monolithically using the same manufacturing method by adjusting the radius of the membranes 22 of the transducers 2. A first array 40 comprising the transducers 2 used for the haptic effects and a second array 40 comprising the transducers used for the sound effects also can be assembled.

The size of the one or more arrays 40 of transducers 2 depends on the one or more desired haptic and/or sound effects.

The unit acoustic pressure P generated by a transducer can be computed based on the surface area Sₘ of its membrane, its carrier frequency f and the distance d at which it is generated, using the following equation of the acoustic pressure originating from a flat piston:

$$P = \frac{\sqrt{2} \cdot π \cdot ρ \cdot {S}_{m} \cdot ϵ \cdot {f}^{2}}{d}$$

With ρ being the average mass density of the membrane and ∈ being the amplitude of the vibration.

In one example of an array 40, the ultrasound transducers 2 that are used are of the PMUT type and operate at a frequency of 100 kHz. However, other types of transducers can be used, such as electromagnetic actuators. The radius of the membrane 22 of the considered PMUT transducers 2 is of the order of 400 μm and the spacing between the membranes 22 of the transducers 2 is of the order of 300 μm, which is enough space to guarantee the reliability of the array 40. For a given frequency, the radius of a transducer 2 depends on the stiffness of its membrane 22, associated with its thickness and its constituent materials.

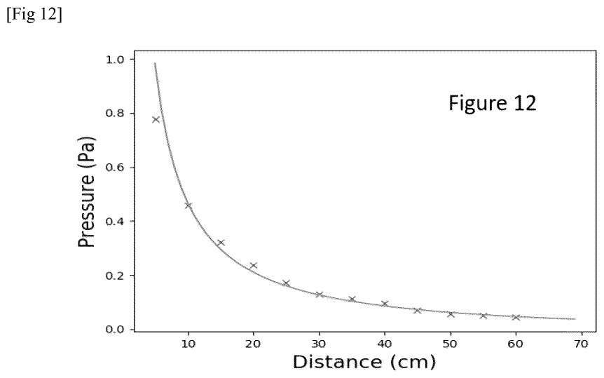

A PMUT transducer 2 operating at 100 kHz and powered with a voltage of 5 V generates an acoustic pressure of the order of 0.15 Pa at a distance of 30 cm, according to the measurements illustrated in FIG. 12. It is possible to assume an acoustic pressure linearly increasing with the voltage up to a maximum voltage of 48 V, corresponding to 1.44 Pa.

It is known to a person skilled in the art that the acoustic pressure threshold for experiencing a haptic effect is approximately 200 Pa. By linearly adding the acoustic pressures generated for a voltage of 48 V, it follows that 139 transducers are required to obtain a haptic effect at 30 cm.

In this example, in order to generate a tactilely perceptible haptic effect at 30 cm, the array 40 therefore has a minimum dimension of the order of 1.5×1.5 cm².

It is known to a person skilled in the art that the acoustic perception threshold for experiencing a sound effect is approximately 120 dB.

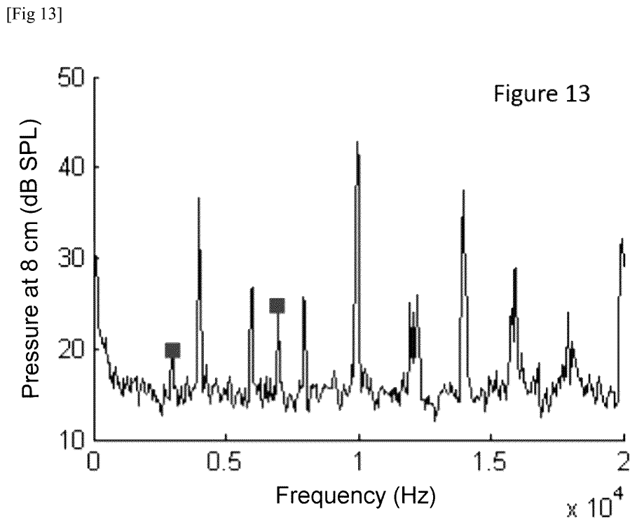

FIG. 13 shows that, in the considered example, 64 PMUT transducers 2 operating at 100 kHz can generate a pressure of 30 dB at 8 cm. Linearly adding the generated acoustic pressures means that 256 transducers are needed to generate a perceptible sound effect at 8 cm, which corresponds to an array with minimum dimensions of the order of 2×2 cm².

Thus, in the considered example, the multimodal interface 1 is made up of at least 395 (139+256) transducers 2 in order to simultaneously generate a haptic effect and a sound effect.

However, it is also possible to contemplate sequentially generating the haptic and sound effects. In this case, a multimodal interface 1 with at least 256 transducers 2 is sufficient to generate both effects.

It is possible to increase the number of transducers 2 in the interface 1 in order to increase the effect, the number of simultaneous effects, and/or to increase the working distance.

The haptic and sound interface 1 can be integrated into a virtual, augmented or mixed reality headset that generates, for example, a scene or a virtual image such as a ball. The user can tap this ball with their hand and the interface 1 can send haptic information relating to contact with the ball. Simultaneously or sequentially, with a delay of the order of several tens of milliseconds, for example, 100 ms, that is imperceptible to the user, the interface 1 can send sound information to the user, who hears a sound in the direction of the ball, giving them the impression that they are hearing the sound of the ball that has been hit.

Of course, the invention is not limited to the examples described above.

The transducers can be produced in ways other than by the manufacturing method described above. For example, the active membranes are produced on a glass support or on a flexible sheet of a polymer. The piezoelectric actuator may or may not be located in the center of the membrane, in the form of a disc or a ring or any other shape and can assume various sizes relative to the size of the membrane. Several piezoelectric actuators can be located on the same membrane, for example, one in the center thereof and one on the periphery. The transducers can be deposited as a thin film or can be transferred directly onto the membrane. As described above, transducers with different membrane sizes can be arranged on the substrate, distributed in any manner.

The ultrasound waves in the considered examples propagate in air, but any type of medium can be considered, for example, a liquid.

The haptic effects can be generated in order to give a user the impression of touching different textures.

The haptic and sound interface 1 can be connected to one or more systems generating a visual effect, for example, at least a screen, mirror or hologram.

1. A multimodal haptic interface, comprising:
a control circuit; and
an array comprising a plurality of ultrasound transducers connected to said circuit;
with the control circuit being configured to modulate the signals sent to the transducers in order to:
generate, with the ultrasound waves emitted by at least some of the transducers, an acoustic pressure that is tactilely detectable on a surface of a user, in at least one first focal zone; and/or
generate, with the ultrasound waves emitted by at least some of the transducers, an acoustic pressure that is audibly detectable by an auditory receiver of the user, in at least one second focal zone.

2. The multimodal interface as claimed in claim 1, further comprising at least one set of transducers arranged to generate haptic effects and sound effects.

3. The multimodal interface as claimed in claim 1, further comprising at least two sets of ultrasound transducers, with a first set of transducers being arranged with the control circuit to generate haptic effects and a second set of transducers not included in the first set being arranged to generate sound effects with the control circuit at the same time as and/or after the haptic effects generated by the first set.

4. The multimodal interface as claimed in claim 1, further comprising at least two sets of ultrasound transducers, with the transducers of a first set and those of a second set having identical active membranes.

5. The multimodal interface as claimed in claim 1, further comprising at least two sets of ultrasound transducers, with the transducers of a first set and those of a second set being supported by the same support.

6. The multimodal interface as claimed in claim 1, further comprising at least one detection system configured to detect the position of at least one surface to be tactilely stimulated and/or of at least one auditory receiver to be audibly stimulated relative to the transducers, with the control circuit being arranged to control the transducers as a function of the position of the surface and/or of the auditory receiver.

7. The multimodal interface as claimed in claim 1, wherein each transducer being of the piezoelectric, ferroelectric, electromagnetic, thermal or ceramic piezoelectric type.

8. The multimodal interface as claimed in claim 1, wherein the control circuit is configured to modulate the signals sent to the transducers in order to generate the audibly detectable acoustic pressure by electronic acoustic focusing.

9. A method for generating one or more mid-air localized tactile and/or sound perceptions using a multimodal interface as defined in claim 1, comprising modulating the control signals sent to the transducers by means of a control circuit in order to:
generate, with the ultrasound waves emitted by the activated transducers, an acoustic pressure that is tactilely detectable on a surface of a user, in a first focal zone; and/or
generate, with the ultrasound waves emitted by the activated transducers, an acoustic pressure that is audibly detectable by an auditory receiver R of the user, in a second focal zone.

10. The method as claimed in claim 10, further comprising the following steps:
determining the one or more spatial positions where the tactile and/or sound perception is to be generated; and
determining the transducers to be activated and computing the phase shift to be applied to these transducers in order to generate the one or more desired tactile and/or sound perceptions.
